(19) United States
(12) Patent Application Publication
(10) Pub. No.: US 2017/0369000 A1
(43) Pub. Date: Dec. 28, 2017

(54) Bicycle-Carrying Device For Motor Vehicles

(71) Applicant: Fabio Pedrini, Bologna (IT)

(72) Inventor: Fabio Pedrini, Bologna (IT)

(21) Appl. No.: 15/698,031

(22) Filed: Sep. 7, 2017

Related U.S. Application Data
(63) Continuation-in-part of application No. 14/921,172, filed on Oct. 23, 2015.

(30) Foreign Application Priority Data
Dec. 24, 2014 (IT) TO2014A001103

(51) Int. Cl. B60R 9/10; B60R 11/00

(52) U.S. Cl. CPC B60R 9/10; B60R 2011/004; B60R 2011/0059

(57) ABSTRACT

A bicycle-carrying device for motor-vehicles comprises a support structure (2) defining a main axis (2A), and a plurality of legs (3) carried by the support structure (2) for abutment on the rear part of a motor-vehicle. At least some of the legs are orientable around the main axis (2A). The device further comprises a plurality of arms (4) carried by the support structure (2) for supporting one or more bicycles. A number of flexible clamping belts (4B) are anchored to the arms and define cradle-like portions (4A) for receiving a frame tube (T) of a bicycle carried by the bicycle-carrying device. Each flexible clamping belt (4B) has a number of projections (411) which are spaced from each other in a longitudinal direction (M) of the belt body (401) and configured to act as spacers when the flexible clamping belt (4B) is clamped around a bicycle tube (T), so as to define gaps (412) through which any bicycle wire (W) extending adjacent to, and along, the bicycle tube (T) can be arranged.

### CROSS-REFERENCE TO RELATED APPLICATION

This application is a continuation-in-part of, and claims the benefit of, copending application Ser. No. 14/921,172 filed Oct. 23, 2015, the entire disclosure and content of which is hereby expressly incorporated by reference.

### FIELD OF THE INVENTION

The present invention relates to bicycle-carrying devices for motor-vehicles, in particular of the type comprising:
a support structure,
a plurality of arms carried by the support structure for supporting one or more bicycles, and
a number of flexible clamping belts anchored to the arms and defining cradle-like portions for receiving a frame tube of a bicycle carried by the bicycle-carrying device.

In devices of this type the problem exists that the outer coating or paint layer of the bicycle tube may be damaged when the flexible clamping belts are clamped around the tube, due to that one or more metal wires which extend adjacent to, and along, the bicycle tube (such as wires for actuating a bicycle brake or derailleur) are pressed by the clamped belt against the tube surface.

### OBJECT OF THE INVENTION

The object of the present invention is that of overcoming the above indicated drawback of the known solutions.

Another object of the invention is that of providing a bicycle-carrying device of the above indicated type in which:
the operations for mounting the device on the motor-vehicle and for dismantling the device from the motor-vehicle are extremely simple, easy and quick,
a high stability is obtained of the bicycle-carrying device during travel of the motor-vehicle, also along the direction transverse to the median vertical plane of the motor-vehicle,
the device has an extremely simple and functional structure and is adapted to assume a configuration of minimum bulk when it is not used,
a high safety is obtained against a non-authorized removal of the bicycle-carrying device from the motor-vehicle,
it is possible for the device to be reconfigured as a function of the shape of the motor-vehicle on which it must be mounted, by simple and quick operations.

### SUMMARY OF THE INVENTION

In view of achieving these and further objects, the invention provides a bicycle-carrying device for motor-vehicles comprising:
a support structure,
a plurality of arms carried by the support structure, for supporting one or more bicycles,
a number of flexible clamping belts anchored to the arms and defining cradle-like portions for receiving a frame tube of a bicycle carried by the bicycle-carrying device,
wherein each of the flexible clamping belts comprises an elongated flat body having a face with a number of projections which are spaced from each other in a longitudinal direction of the belt body and configured to act as spacers when the flexible clamping belt is clamped around a bicycle tube, so as to define gaps between the belt body and the tube surface, through which any bicycle wire extending adjacent to, and along the bicycle tube can be arranged. Representatively, the projections have a height of at least 2 millimetres.

The height of at least 2 millimeters ensures that any standard metal wire extending along a bicycle tube is received with clearance through the above indicated gaps created by the projections of the body of the clamping belt. Therefore, the above-indicated problem of the prior solutions is solved, since clamping of the clamping belts around a bicycle tube cannot cause any bicycle wire extending along the tube to be pressed against the tube outer coating, which eliminates the risk of a damage of this outer coating.

In a representative embodiment, the elongated flat body has a first face on which a ratchet rack is formed. A buckle is provided at one end of the elongated flat body. A pawl is pivoted to the buckle, the pawl having a tooth adapted to be biased by a spring into engagement with the ratchet rack in a clamped condition of the flexible clamping belt, the elongated flat body having a second face having the projections.

In an exemplary embodiment, the support structure defines a main axis, the device further comprises:
a plurality of legs carried by the support structure for abutment on the rear part of a motor-vehicle, at least some of the legs being orientable around the main axis,
a plurality of belts or cables each having a hook member to be engaged on a motor-vehicle part, for anchoring the bicycle-carrying device to the motor-vehicle,
one or more roll-up devices for winding the belts or cables around respective winding axes, and
wherein at least some of the legs have respective roll-up devices each arranged within an inner cavity of the respective leg and having a winding axis located at a position spaced apart from the main axis.

Due to these features, each anchoring belt or cable can be stored inside a respective leg of the bicycle-carrying device. At the same time, since each roll-up device is arranged at a position spaced apart from the main axis, it does not interfere with the leg portion which is mounted on the support structure. As a consequence, if this is desired, it is possible to provide all of the legs of the bicycle-carrying device with respective roll-up devices.

Thus, according to a preferred solution, all the legs have respective roll-up devices each arranged within an inner cavity of the respective leg, with the winding axis located at a position spaced apart from the main axis.

The invention is also directed to the flexible clamping belt according to claim 7 and the method according to claim 12.

### BRIEF DESCRIPTION OF THE DRAWINGS

Further features and advantages of the invention will become readily apparent from the following description with reference to the annexed drawings, given purely by way of non-limiting example, in which:

FIG. 1 is a perspective view of a preferred embodiment of a bicycle-carrying device according to the present invention,

FIG. 1A is a perspective exploded view of the bicycle-carrying device of FIG. 1,

FIGS. 2-4 are further perspective views of the bicycle-carrying device of FIG. 1,

FIG. 5 is a plan view of a leg forming part of the bicycle-carrying device of FIG. 1,

FIG. 6 is a cross-sectional view taken along line VI-VI of FIG. 5,

FIG. 6A shows the cross-sectional view of FIG. 6 with the leg in a different condition of use,

FIG. 7 is a view at an enlarged scale of a detail of FIG. 6,

FIG. 8 is a perspective exploded view of a roll-up device forming part of the bicycle-carrying device according to the invention,

FIGS. 9-11 are views in cross-section and at an enlarged scale of the roll-up device of FIG. 8, which show three different operative conditions of the roll-up device,

FIGS. 12-14 show a clamping device forming part of the bicycle-carrying device according to the invention, at an enlarged scale, in three different operative conditions,

FIG. 15 is an exploded perspective view of a detail of an arm forming part of the bicycle-carrying device according to the invention, provided with an anti-theft device,

FIG. 16 is an exploded perspective view of one of the flexible clamping belts forming part of the bicycle-carrying device according to the present invention,

FIG. 17 is a perspective view of the opposite side of the flexible clamping belt of FIG. 16,

FIG. 18 shows a variant of FIG. 17, corresponding to a different embodiment of the flexible clamping belt,

FIG. 19 shows a side view of both the embodiments of FIGS. 17,18, and

FIG. 20 shows a cross-section of a frame tube of a bicycle carried by the device of the present invention, in a condition clamped by the above mentioned flexible clamping belt.

### DETAILED DESCRIPTION

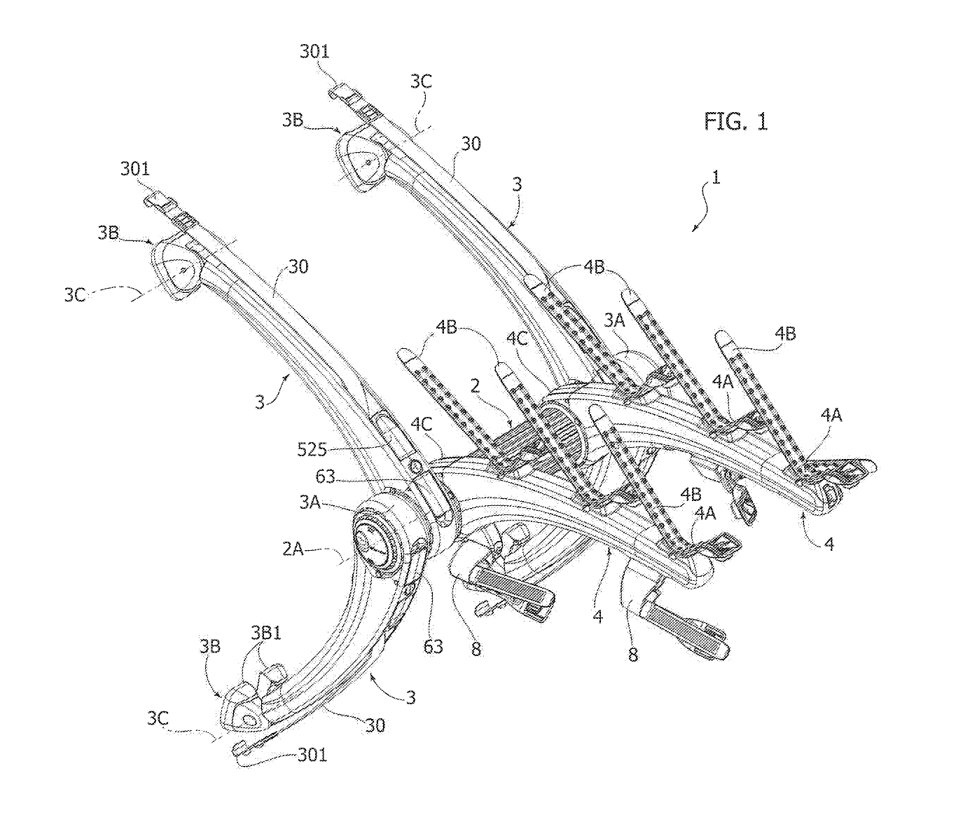

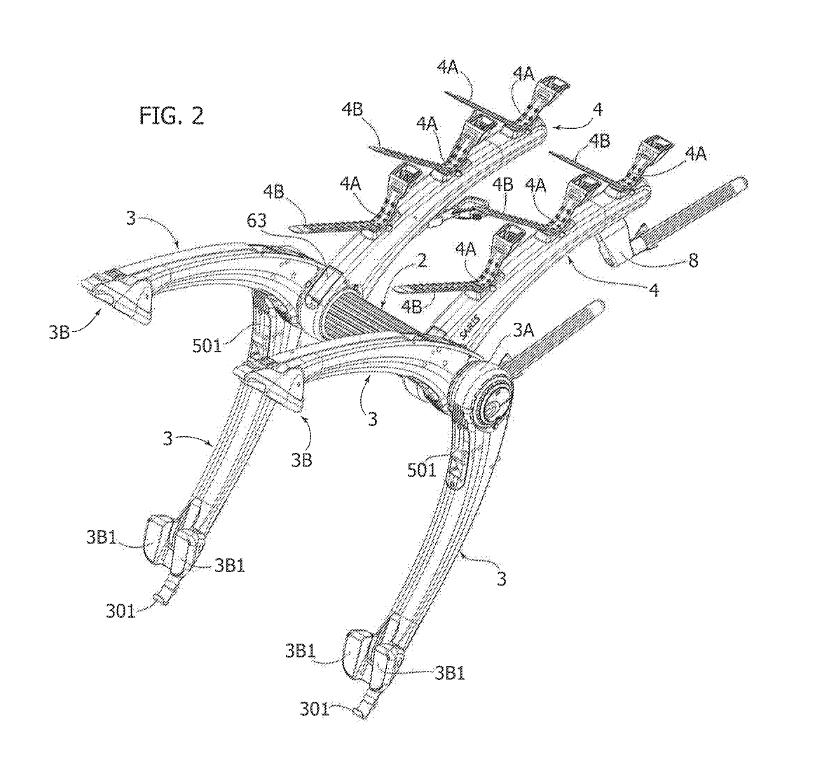

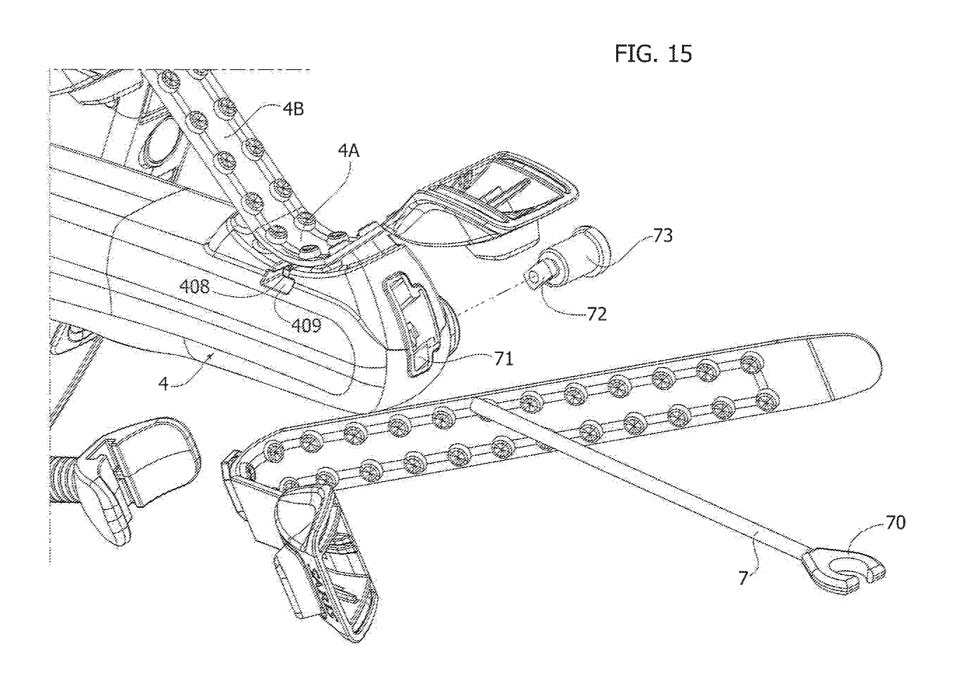

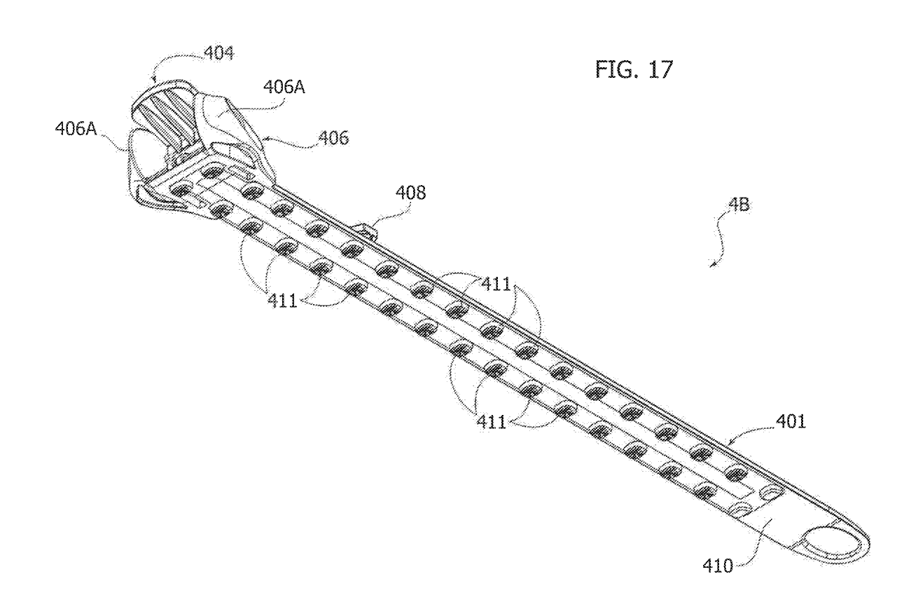

FIGS. 1-15 are identical to FIGS. 1-15 of US 2016/0185304 A1. However, these figures are applicable also to the device according to the present invention, provided that the flexible clamping belts are formed according to the teachings of the present invention, such as shown for example in FIG. 16 or FIG. 18.

In FIGS. 1-4, reference numeral 1 generally designates a preferred embodiment of a bicycle-carrying device according to the invention.

In this embodiment, the bicycle-carrying device 1 comprises a support structure constituted by a fluted shaft 2, for example having a tubular body made of aluminium, which in the mounted condition of the device 1 on the motor-vehicle is arranged with its axis 2A directed transversally, i.e. orthogonally to the median vertical plane of the motor-vehicle. On the fluted shaft 2 there are mounted the hubs 3A of two pairs of legs 3 each provided with an abutting foot 3B which is to abut against the rear part of a motor-vehicle. In the illustrated example, each foot 3B has a body pivotally mounted on the free end of the respective leg 3 around a transverse axis 3C and including two foot portions 3B1 which are spaced apart transversally from each other.

The bicycle-carrying device 1 further comprises a pair of arms 4 which are for supporting bicycles, in a way known per se, on a plurality of cradles 4A each provided with a flexible clamping belt 4B. Each arm 4 also has a hub 4C which is mounted and locked over the fluted shaft 2.

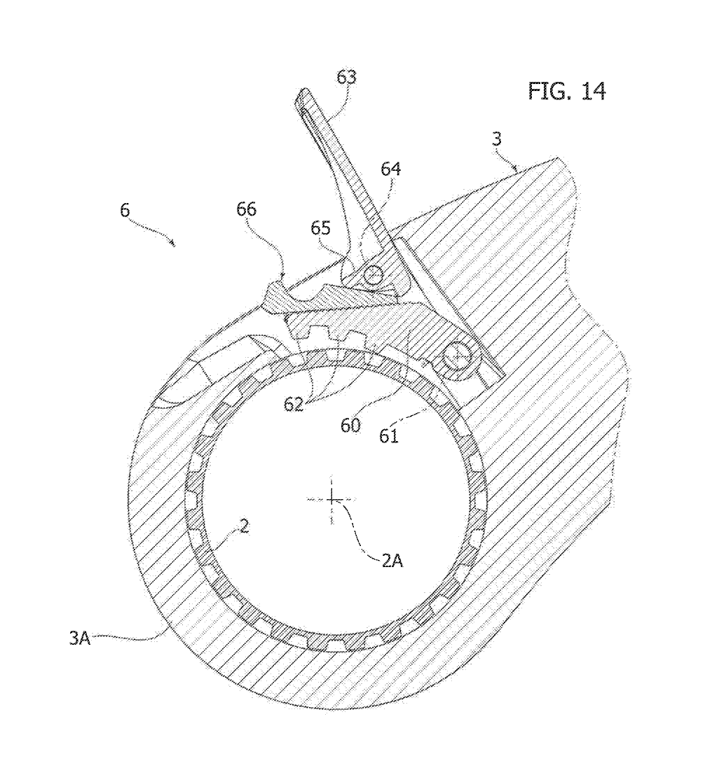

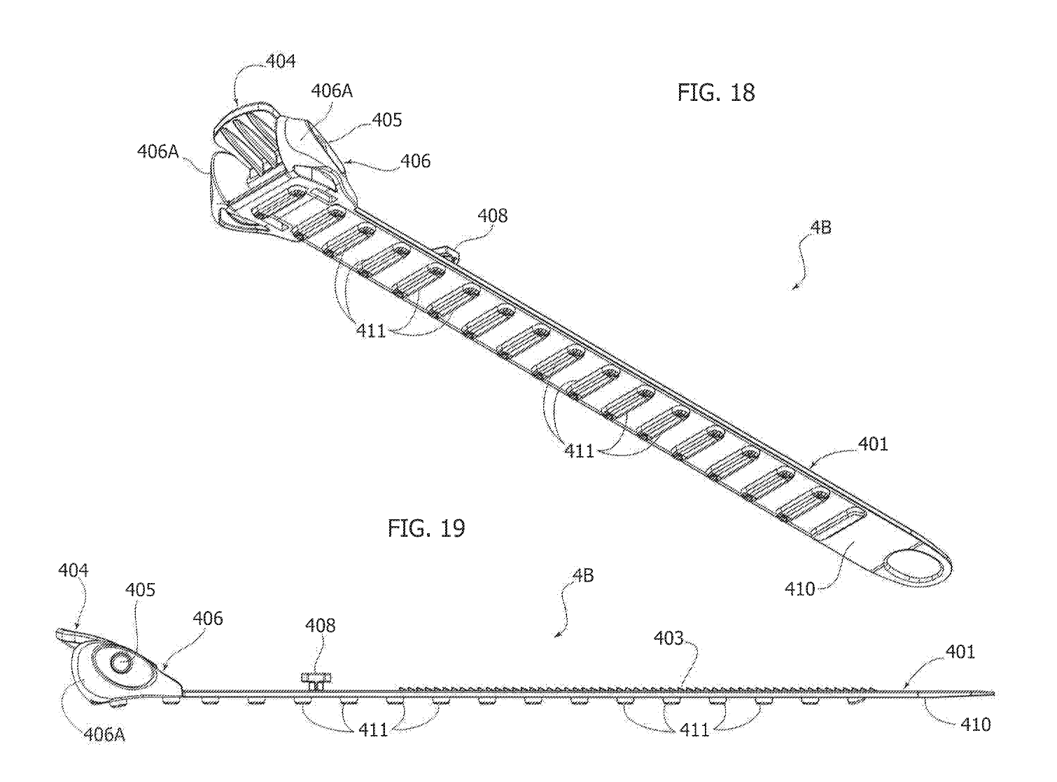

FIGS. 16, 17 and 19, 20 show a first embodiment of the flexible clamping belt 4B. With reference to these figures, the clamping belt 4B has an elongated flat body 401 including one or more layer of any suitable material, such as a synthetic elastomeric material. The flat body 401 has a first face 402 on which a ratchet rack 403 is formed, including teeth adapted to cooperate with a tooth 404A of a pawl 404. Pawl 404 is pivotally mounted by means of a pivot pin 405 between two supporting wings 406 projecting from one end of the elongated flat body 401. The wings 406 form part of a buckle portion through which the opposite end of the belt body 401 can be inserted when the belt is to be clamped. A coil spring 407 is mounted around pin 405 and engaged between one wing 406 and the pawl 404 to bias pawl 404 to a position engaging rack 403. Pawl 404 can be moved away from this engaging position, against the action of spring 407, by pressing the end 404B of pawl 404 opposite to the tooth 404A. On the face 402 of the elongated flat body 401, also a T-shaped projection 408 is formed which is to be received by a sliding movement within one of a number of cooperating seats 409 (see FIG. 15) formed in the arms 4.

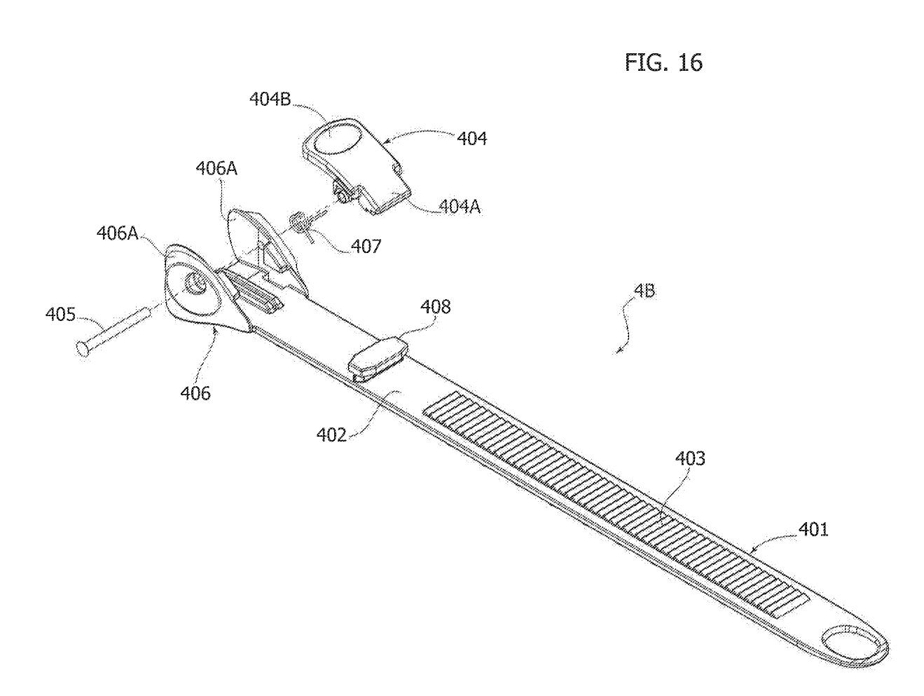

The opposite face 410 of body 401 (see FIG. 17) has a distribution of projections 411 arranged in pairs on the two sides of a median longitudinal axis M of the belt body 401. The projections 411 of each pair are aligned with each other along a direction orthogonal to the axis M. The various pairs of projections 411 are spaced apart from each other in the direction of the axis M, so that a portion of face 410 free from projections is left between adjacent pairs.

When a bicycle is received on the two arms 4, a frame tube of the bicycle rests on each cradle-like portion defined by the inner face 410 of a respective clamping belt 4B (see FIG. 15). In this condition, the bicycle tube can be clamped by the flexible clamping belt by inserting the free belt end through the buckle and pulling this free end to tighten the belt around the tube, the pawl 404 cooperating with the rack 403 to hold the belt 4B in any desired clamping configuration.

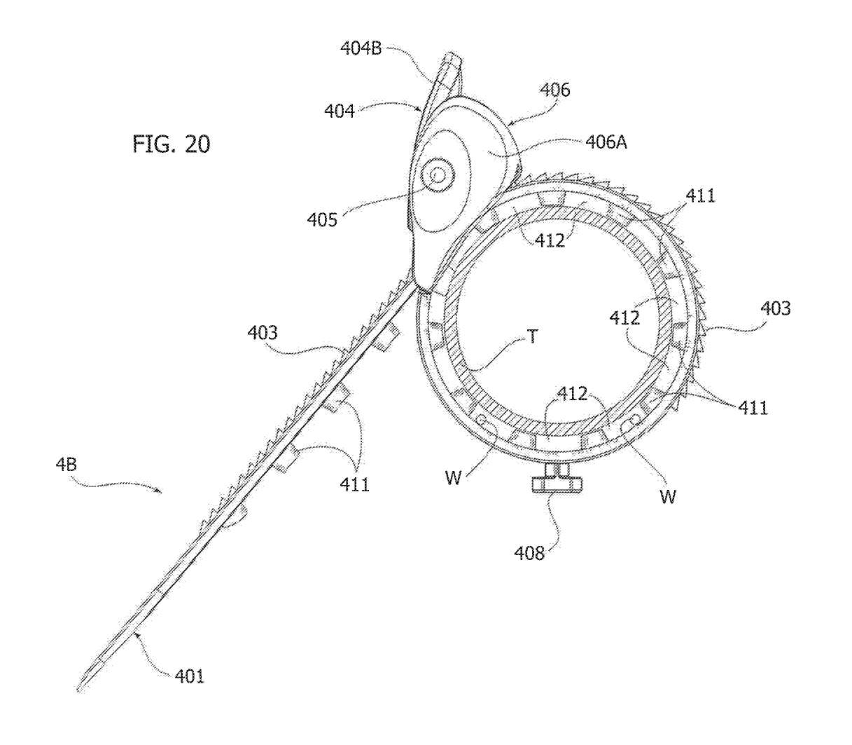

FIG. 20 shows a cross-section of belt 4B clamped around a bicycle tube T. For clarity of illustration, this figure only shows the bicycle tube T clamped by the belt 4B, the arm 4 being not illustrated. As clearly apparent in FIG. 20, when the belt 4B is clamped around the tube T, the projections 411 of the belt body engage the tube surface so as to act as spacers, defining gaps 412 between the belt body 401 and the tube surface.

Thanks to this arrangement, metal wires W forming part of the bicycle (e.g. wires for actuating a bicycle brake or a bicycle derailleur), which extend adjacent to and along the surface of the bicycle tube, can be arranged through the gaps 412, so that they are not pressed between the belt body 401 and the surface of tube T. In this manner, the drawback is avoided of having the tube outer coating or paint layer being damaged by the wire or wires when the belt is tightened around the tube. To this end, the projections 411 are provided with a height substantially greater than the diameter of a standard metal wire as used in bicycles, i.e. greater than 2 millimetres. Moreover, the projections 411 are sufficiently stiff to ensure that they provide the required spacing when they are compressed against the tube surface. For this purpose, it is also possible to have the projections 411 made of a material different from the material of body 401 and selected to ensure the required stiffness.

FIG. 18 shows a variant of FIG. 17, corresponding to a second embodiment of the flexible clamping belt 4B, where in place of each pair of projections 411 of FIG. 17 a single transversally elongated projection 411 is provided, which occupies a major portion of the belt width. The various elongated projections 411 of FIG. 18 are also spaced longitudinally from each other for providing the required gaps 412.

While the clamping belt 4B is shown and described in connection with a bicycle-carrying device having a certain construction and configuration as shown and described herein, it should be understood that the belt 4B may be used in any type of bicycle carrying device in which a belt or other flexible member is wrapped about a tube or other portion of the bicycle having a wire or cable adjacent its outer surface. That is, the belt 4B may be used with a trunk-mounted or hatch-mounted carrier as shown and described, or with a hitch-mounted carrier. In addition, while the projections 411 are shown and described with respect to the belt 4B, which has a ratchet-and-pawl arrangement for securing the belt 4B about the bicycle tube or component, it should be understood that the projections such as 411 may be employed on a belt having any other type of engagement arrangement that maintains the belt secured about the bicycle tube or other component such as, for example, an engagement arrangement having one or more pegs at one end that are received within one or more openings at the opposite end.

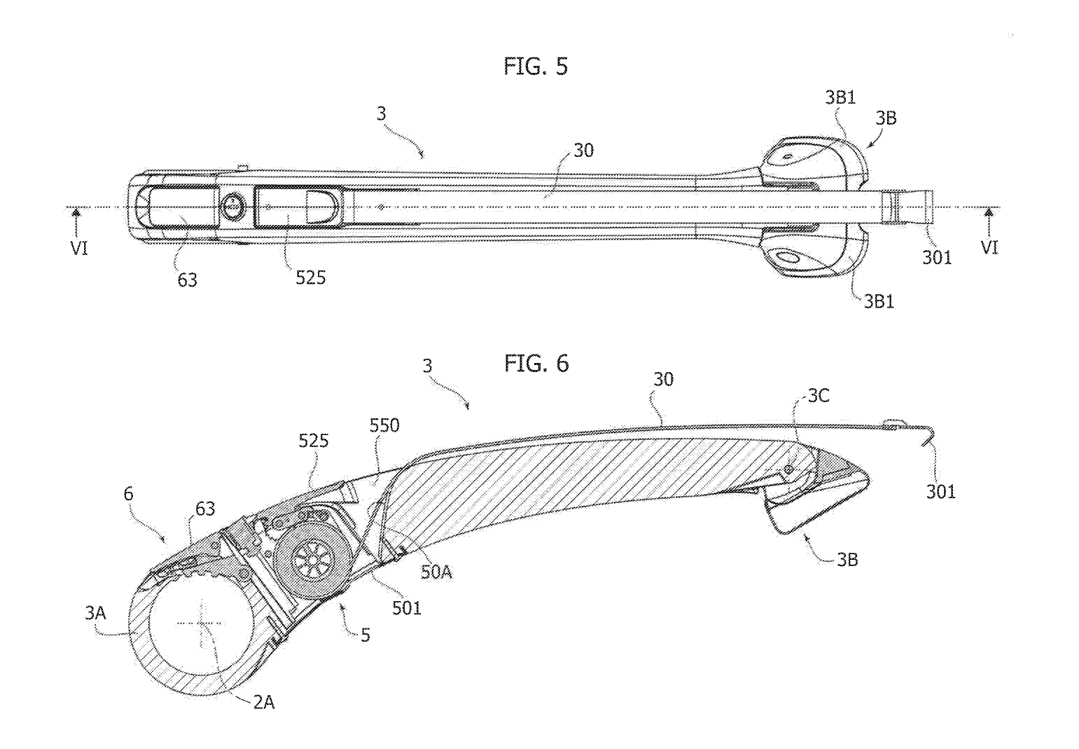

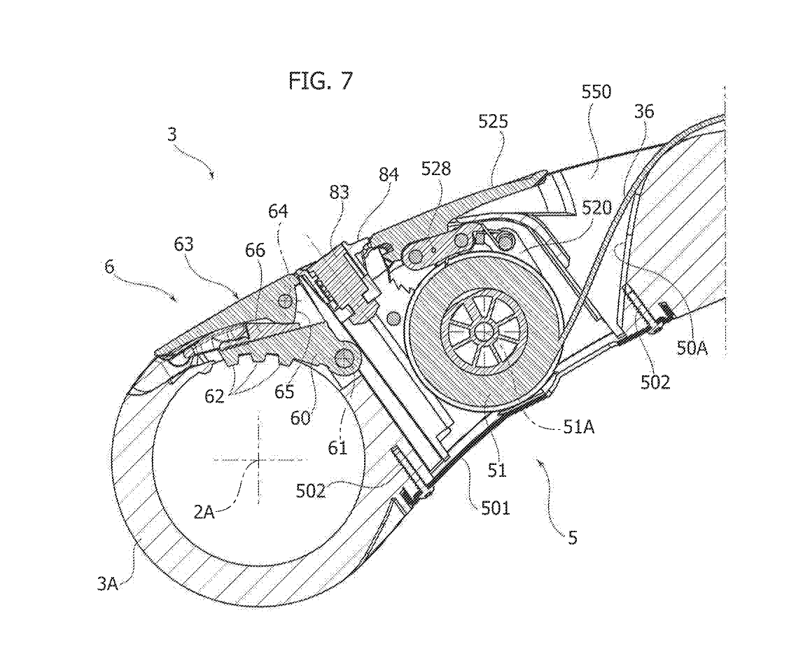

Anchoring belts 30 are associated with the four legs 3 which are provided with feet 3B for abutment on the rear part of the motor-vehicle, one belt being associated with each leg. Each belt 30 has one end provided with a hook member 301 which is to be engaged on the edge of a motor-vehicle part (such as the edge of the trunk or the rear door). On the opposite end, the anchoring belt 30 can be wound within a roll-up device 5 (FIG. 8) carried by a casing 50 mounted within an inner cavity 50A arranged within the body of the respective leg 3 (see for example FIG. 6) at a position spaced apart from axis 2A of hub 3A.

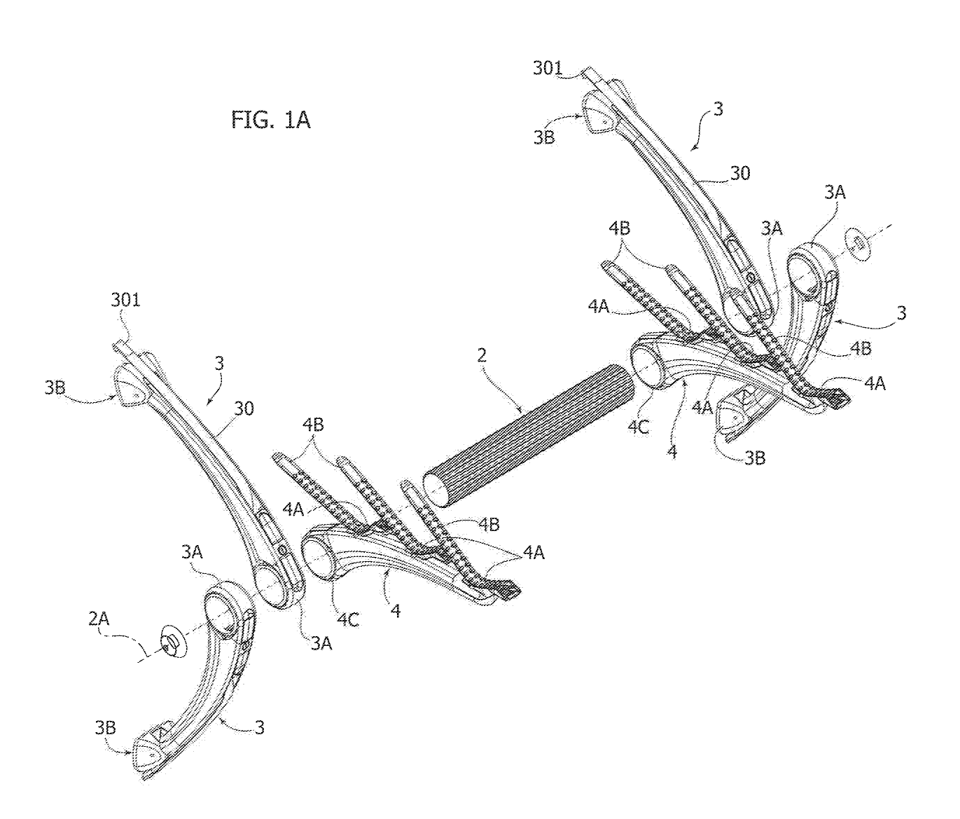

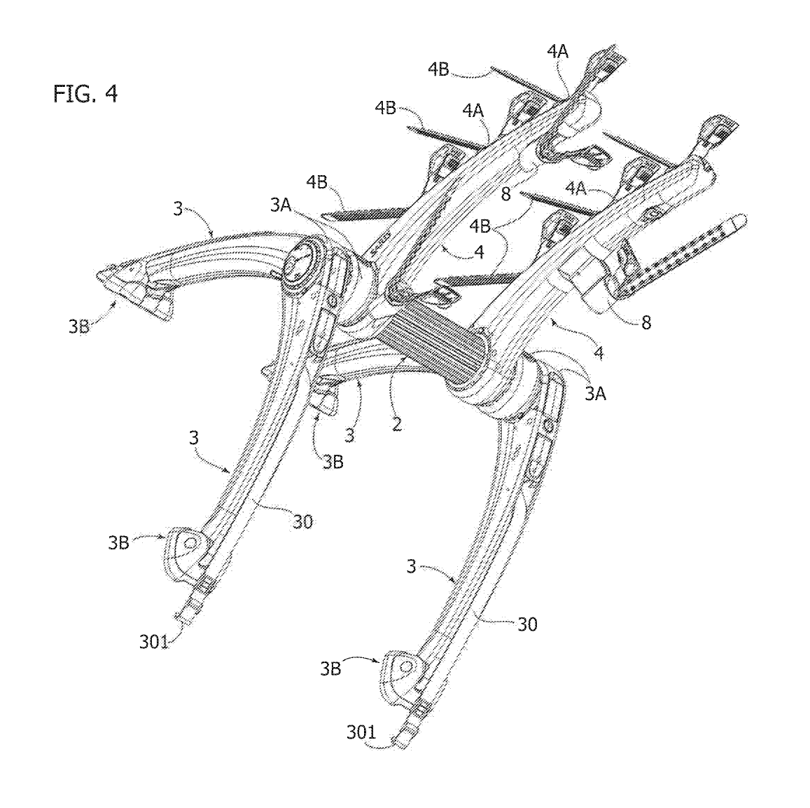

With reference to FIGS. 5-11, and in particular to FIG. 8, the support casing 50 of each roll-up device 5 has, in the case of the illustrated example, a base flange 501 provided with holes for engagement of connecting screws 502 which secure the flange on the outer surface of the respective leg 3 (see also FIG. 2). The casing 50 further comprises two parallel and spaced apart plates 503 between which there is arranged a support pin 504 constituted by two mutually engaged pin elements 504A,504B. Pin 504 rotatably supports a reel 51 around a winding axis 51A, for winding the respective anchoring belt 30. A flat spiral spring 510 is arranged within the reel 51 and is operatively interposed between the reel and the pin 504 which is secured to casing 50, for biasing the reel 51 in the direction for winding the belt 30.

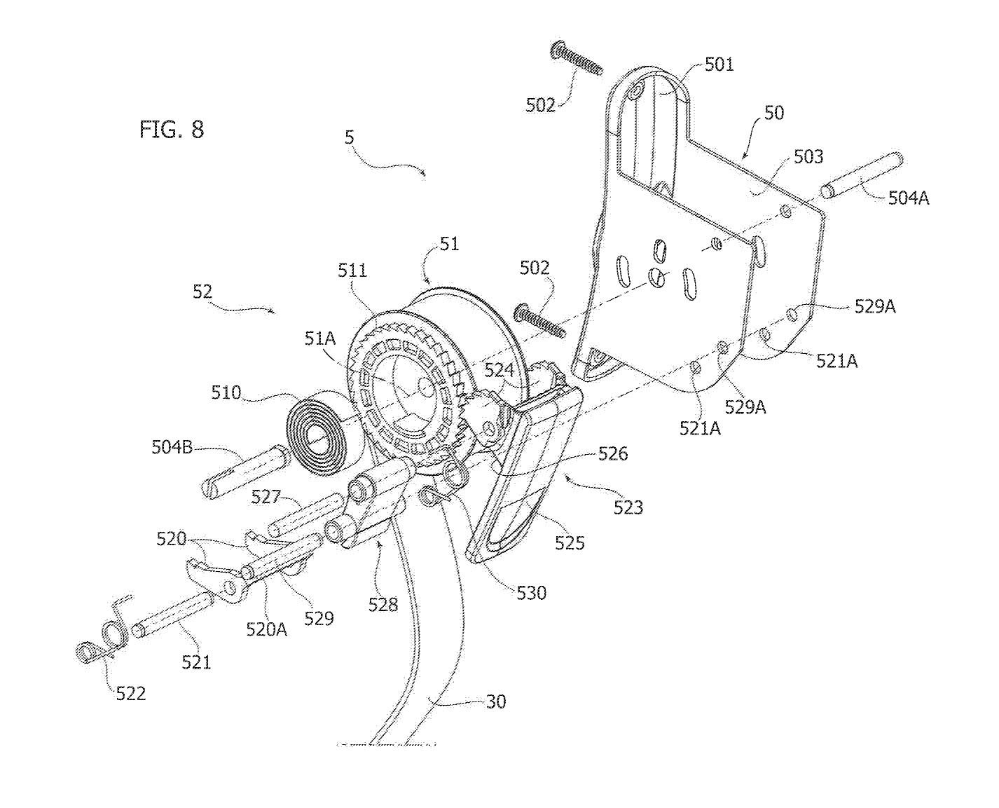

Also with reference to FIG. 8, the two opposite faces of reel 51 carry two toothed crowns 511 (only one of which is visible in FIG. 8) having saw-tooth-shaped teeth, forming part of a ratchet mechanism generally designated by reference numeral 52 in FIGS. 9-11. The ratchet mechanism 52 further comprises, in the case of the illustrated example, a pair of pawls 520 (FIG. 8) carried by a pin 521 whose ends are secured to plates 503 within respective holes 521A. A pin spring 522 is operatively interposed between the assembly of the two pawls 520 and the casing 50 for biasing the two pawls 520 towards a position for engagement of the respective toothed crowns 511, visible in FIG. 9.

In this engagement position, the pawls 520 prevent a rotation of the reel 51 having the toothed crowns 511 in the direction for winding the belt 30.

On the contrary, if the reel 51 rotates in the direction for winding the belt 30, the pawls 520 do not prevent this rotation, but rather repeatedly jump on the toothed crowns 511, due to the elastic bias of spring 522.

The ratchet mechanism 52 further comprises a tensioning member 523 which in the illustrated example comprises a pair of toothed sectors 524 in engagement with the toothed crowns 511. The two toothed sectors 524 are rigidly connected to two parallel and spaced apart plates 526 forming part of the body of an actuating lever 525. The two plates 526 with toothed sectors 524 are pivotally mounted on the ends of a pin 527 (see FIG. 8) which project from the body of a link member 528.

The link member 528 is pivotally mounted on a pin 529 whose ends are secured to plates 503 of the casing 50 within holes 529A. A pin spring 530 is operatively interposed between the link member 528 and the casing 50 for biasing the link member 528 towards a position in which the toothed sectors 529 are in engagement on the respective toothed crowns 511 (see FIG. 9). With reference to FIG. 9, also the teeth of the toothed sectors 524 are saw-tooth-shaped teeth and are arranged so that, in the condition of engagement of sectors 524 on the toothed crowns 511, the sectors 524 prevent a rotation of reel 51 in the direction for unwinding the belt 30.

Also with reference to FIG. 9, the link member 528 has a nose 528A projecting beyond the articulation pin 529 and adapted to cooperate with a cross-member 520A which connects the two pawls 520 to each other, in a way that will be described in the following.

The operation of the above described roll-up device is as follows.

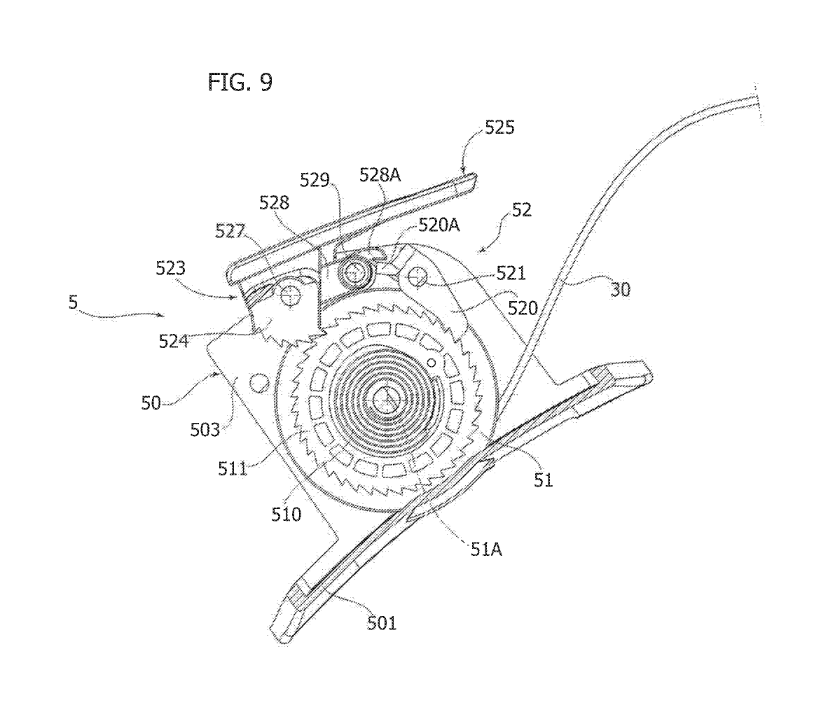

With reference to FIG. 9, when the pawls 520 and the toothed sectors 524 are in their rest condition, they are both in engagement with the respective toothed crowns 511 of the reel 51. If the hook member 301 of the belt 30 is already in engagement on a motor-vehicle part, the belt 30 can be tensioned by winding the belt within the respective roll-up device 51 to the necessary extent. To this end, the actuating lever 525 is repeatedly moved from the rest position shown in FIG. 9 to a first operative position, or tensioning position, which is shown in FIG. 10. Following this rotation, the toothed sectors 524 rotate around the axes of the respective pin 527 causing a rotation of the reel 51 in the winding direction of the belt. This rotation takes place while causing the repeated jumping of pawls 520 on the toothed crowns 511. Once the belt 30 has been tensioned, a stable anchoring of the bicycle-carrying device on the motor-vehicle is obtained.

In this condition, spring 110 would be free to further wind the belt 30, but it is not able to do so, since it is contrasted by the tension of the belt.

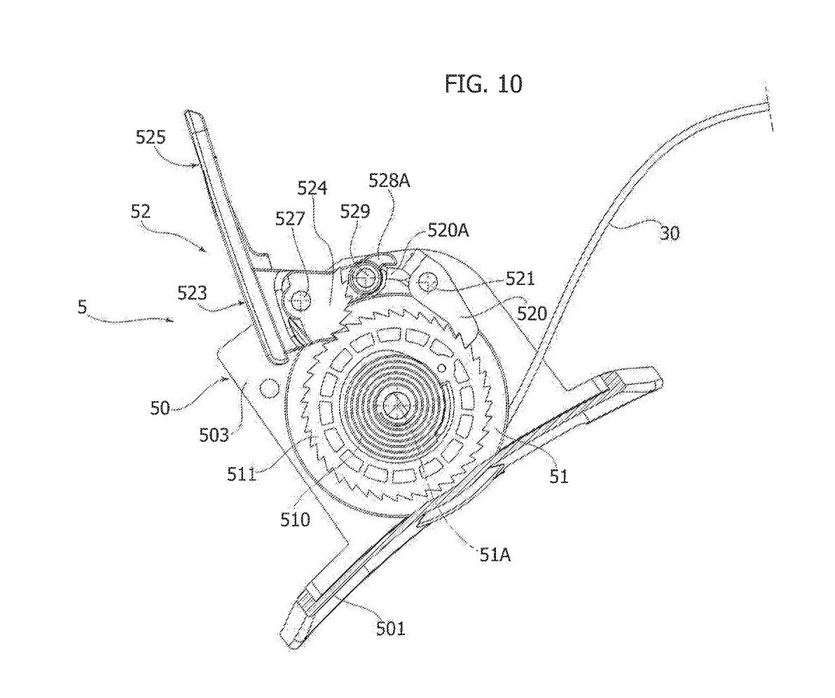

With reference to FIG. 11, the actuating lever 525 has a second operative position, or release position, rotated in the opposite direction with respect to the tensioning position (i.e. in a clockwise direction with reference to the figure) starting from the neutral rest position. In this release position, lever 525 causes rotation of the link member 528 around the respective fixed pin 529, with the consequence that nose 528A presses on the cross-member 520A of the pawls 520 thus keeping them disengaged from the toothed crowns 511. In this condition, if the hook member 301 is disengaged from the motor-vehicle, the belt 30 is quickly retracted within the roll-up device, due to the biasing action of spring 510. In this condition, also the toothed sectors 524 are disengaged from the toothed crowns 511, so that they do not prevent the free winding of the belt.

The operative release position of the lever 525 which is shown in FIG. 11, in which the rotation of reel 51 is free, can be exploited also during the mounting stage of the device, since the user can start by engaging the hook members 301 of two legs 3 of device 1 over the motor-vehicle and then he can manually position the bicycle-carrying device on the motor-vehicle while holding the two respective actuating levers 525 pressed in the position shown in FIG. 11. In this manner, the user can cause the free unwinding of belts 30 from the respective roll-up devices, while progressively moving the bicycle-carrying device away from the anchoring points of the hook members 301. When the desired length of belts 30 is reached, the user can release the two actuating levers 525 which thus return to the position shown in FIG. 9, locking the respective roll-up devices. At this moment, the user can engage also the remaining two anchoring belts on the motor-vehicle and finally he can attend to tensioning each of the four anchoring belts 30 by repeated movements of the actuating levers 525 between the position shown in FIG. 9 and the position shown in FIG. 10.

Naturally, while the roll-up device 5 has been illustrated in an example comprising two toothed crowns 511 cooperating with two pawls 520 and two toothed sectors 524, in principle it is possible to provide a single toothed crown cooperating with a single pawl and a single toothed sector.

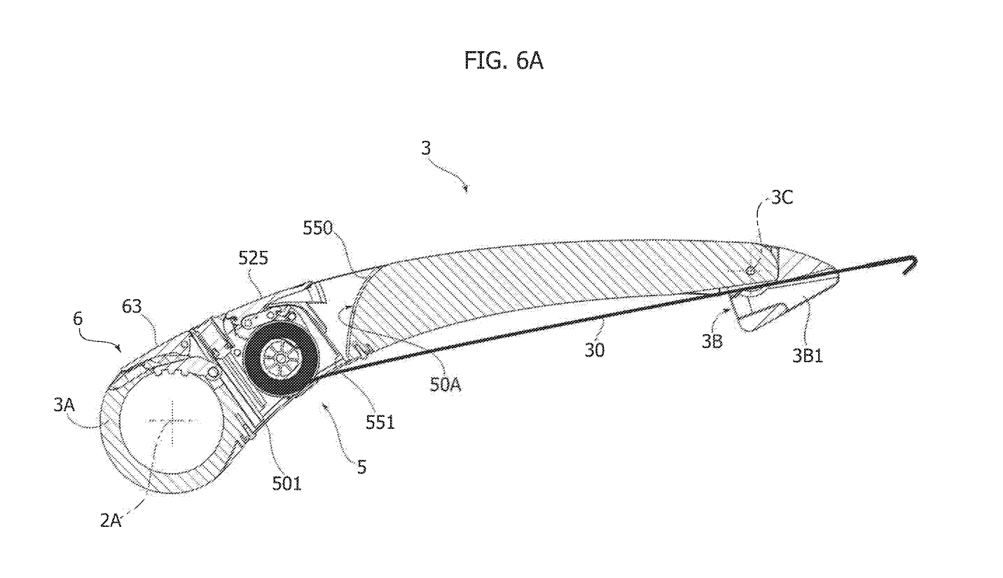

With reference to FIG. 7, with each roll-up device 5 there is associated a key-operated release-inhibition device, comprising a cylinder lock 83 which controls the movement of a locking member 84 between a rest position and an active position, in which it inhibits a movement of the actuating lever 525 towards the release position. A non-authorized release of the belts is thus prevented, once the bicycle-carrying device has been mounted and locked on the motor-vehicle.

According to a further feature, each belt (made for example of fabric or synthetic material) is reinforced with a plurality of cables made of steel, preferably zinc-plated steel, having an anti-collision and an anti-cut function.

With reference to FIGS. 6, 6A, the roll-up device has two outlets 550 and 551 located on two opposite faces of the respective leg, which can be used selectively for guiding the belt or cable pulled out from the roll-up device respectively adjacent to one or the other of the opposite faces. In the condition of use shown in FIG. 6A, in which the belt is adjacent to the lower face of the leg (with reference to the figure), the belt is arranged between two portions 3B1 of the foot 3B, so that once the respective hook 301 is engaged on the motor-vehicle, the belt 30 opposes any movements of the leg 3 along a direction transverse to the median vertical plane of the vehicle.

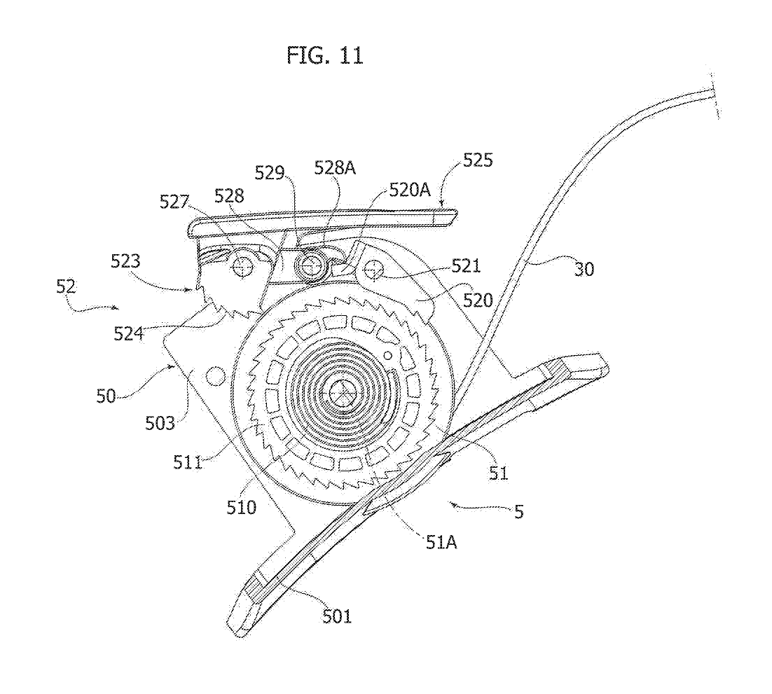

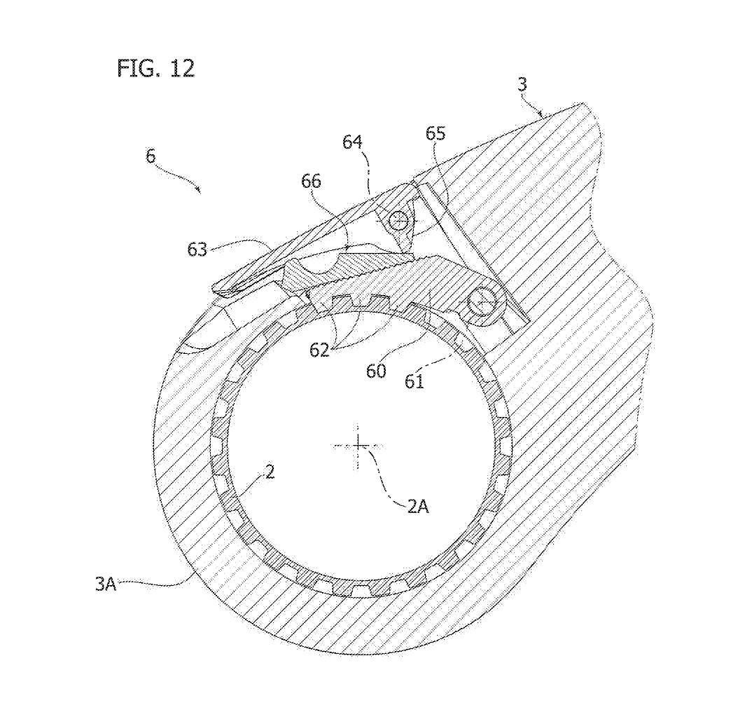

FIGS. 12-14 show the clamping device which is preferably associated with hubs 3A,4C of each leg 3 and each arm 4, for clamping each hub on the fluted shaft 2. The figures refer in particular to the case of a leg 3. In this figures, the clamping device associated with each hub 3A comprises a jaw 60 pivotally mounted around an axis 61 on the body of leg 3 and having teeth 62 for engagement on the outer fluted surface of the transverse shaft 2. The clamping device 6 further comprises a locking lever 63 pivotally mounted around an axis 64 on the body of leg 3 and carrying (in the case of the illustrated example, in one piece with lever 63) a cam member 65 for pressing jaw 60 against shaft 2. The locking lever 63 is movable between a release position, visible in FIG. 13, and a locking position, visible in FIG. 12, in which the cam member 65 has passed a dead centre position, which prevents an undesired return of the locking lever 63 to the release position. Also with reference to FIGS. 12-14, between the cooperating surfaces of the cam member 65 and locking jaw 60 there is interposed an intermediate wedge-like member 66.

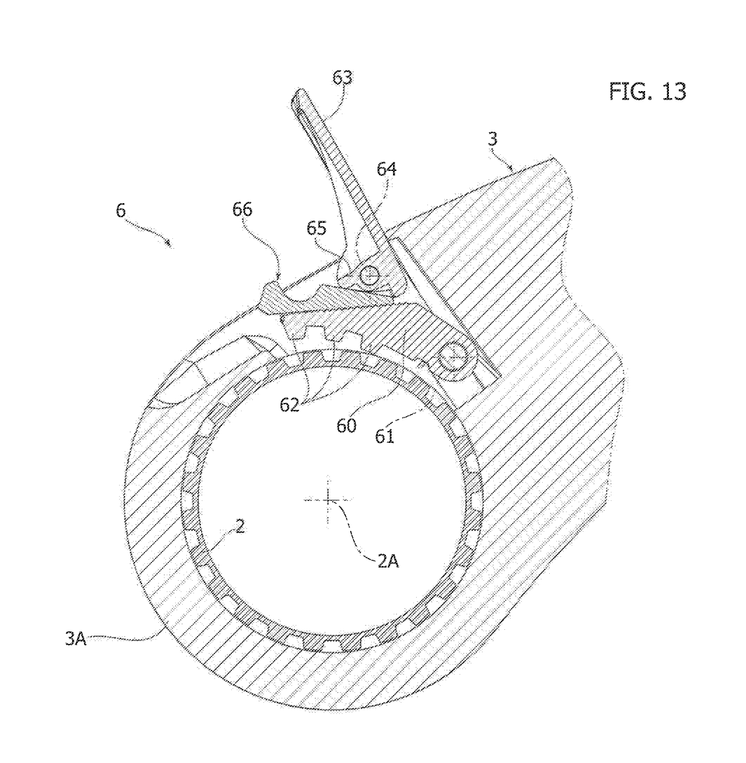

As shown in FIG. 14, in the release position of lever 63, the intermediate wedge-like member 63 can be advanced or retracted in its position interposed between the elements, to enable an adjustment of the clamping force. In order to obtain a precise reference of the mounting position of the wedge-like intermediate member 66, the surfaces of member 66 and locking jaw 60 which are in contact with each other have parallel micro indentations.

Although the example illustrated herein makes use of a fluted shaft 2 and the jaw 60 has teeth cooperating with the fluted surface of the shaft, it is not excluded that the shaft has a non-fluted surface, such as a surface having a high friction coefficient cooperating with a jaw surface which also is made with a high friction coefficient.

With reference to FIG. 15, at least one of the arms 4 carries inside therein a metal cable 7, which can be pulled out from the arm, having an anti-theft function, this cable having a free end with a fork-like shape 70. Cable 7 can be arranged around a frame element of a bicycle carried on the bicycle-carrying device, after which the fork-shaped end 70 can be received within a seat 71 formed in the free end of arm 4 and locked therein by means of a locking member 72 controlled by a rotatable cylinder of a cylinder lock 73, operable by a key.

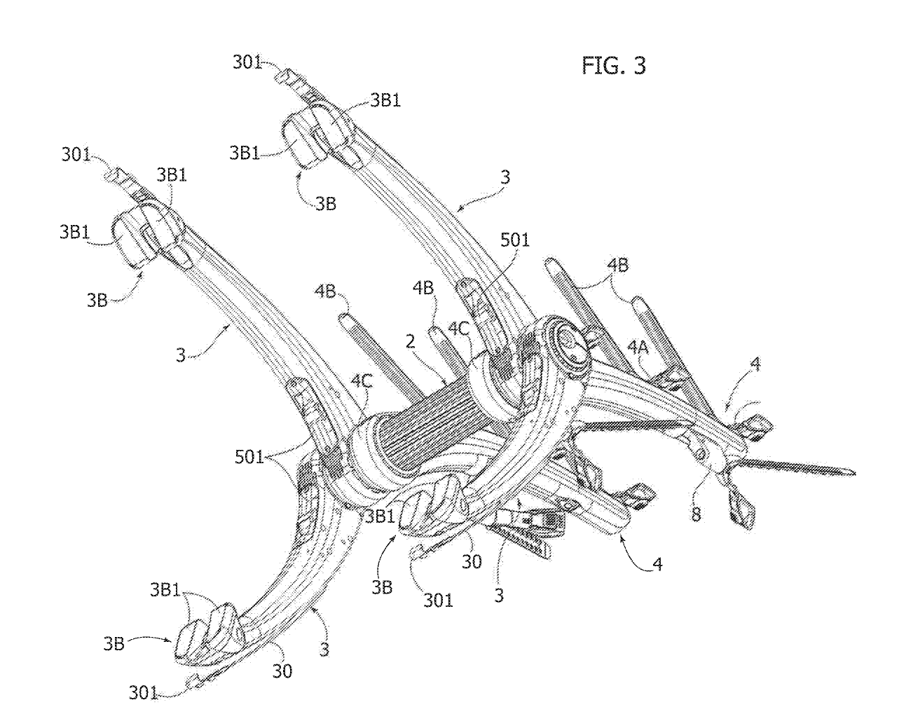

In the illustrated example, the bicycle-carrying device is further provided with members for opposing an oscillation (anti-sway members) of the transported bicycles, which are constituted by supports 8 associated with the arms 4 (see FIGS. 1 and 4) and provided with respective clamping belts. According to a preferred feature, each anti-sway member is adjustable in position due to a threaded coupling.

Naturally, while the principle of the invention remains the same, the details of construction and the embodiments may widely vary with respect to what has been described and illustrated purely by way of example, without departing from the scope of the present invention.

1. Bicycle-carrying device for motor-vehicles, comprising:
a support structure (2),
a plurality of arms (4) carried by the support structure (2), for supporting one or more bicycles,
a number of flexible clamping belts (4B) anchored to the arms (4) and defining cradle-like portions for receiving a frame tube (T) of a bicycle carried by the bicycle-carrying device,
wherein each of the flexible clamping belts (4B) comprises an elongated flat body (401) having a face (410) with a number of projections (411) which are spaced apart from each other in a longitudinal direction of the belt body (401) and configured to act as spacers when the flexible clamping belt (4B) is clamped around a bicycle tube (T), so as to define gaps (412) between the belt body (401) and the surface of the tube (T), through which any bicycle wire (W) extending adjacent to, and along, the bicycle tube (T) can be arranged.

2. Bicycle-carrying device according to claim 1, wherein the projections (T) have a height of at least 2 millimetres

3. Bicycle-carrying device according to claim 1, wherein the projections (411) are arranged in pairs which are longitudinally spaced from each other, the projections (411) of each pair being spaced from each other in a direction transverse to the longitudinal direction of the belt (4B), at the two sides of a belt longitudinal median axis (M).

4. Bicycle-carrying device according to claim 1, wherein each of the longitudinally spaced projections (411) is elongated in a direction transverse to the longitudinal direction of the belt (4B) and occupies a major portion of the width of the belt (4B).

5. Bicycle-carrying device according to claim 1, wherein the first face of the belt has a T-shaped projection (408) which is adapted to be received by a sliding movement within a cooperating seat (409) of one of the arms (4) for anchoring the clamping belt (4B) to the arm (4).

6. Bicycle-carrying device according to claim 1, wherein:
the elongated flat body (401) has a first face (402) on which a ratchet rack (403) is formed,
a buckle (406) is provided at one end of the elongated flat body (401),
a pawl (404) is pivoted to the buckle (406), the pawl having a tooth (404A) biased by a spring (407) into engagement with the ratchet rack (403) in a clamped condition of the flexible clamping belt (4B), and
the elongated flat body (401) has a second face (410) having the projections (411).

7. Bicycle-carrying device according to claim 1, wherein the support structure (2) defines a main axis (2A), the device further comprising:
a plurality of legs (3) carried by the support structure (2) for abutment on the rear part of a motor-vehicle, at least some of the legs being orientable around the main axis (2A),
a plurality of belts or cables (30) each having a hook member (301) to be engaged on a motor-vehicle part, for anchoring the bicycle-carrying device to the motor-vehicle,
one or more roll-up devices (5) for winding the belts or cables (30) around respective winding axes (51A), and
wherein at least some of the legs (3) have respective roll-up devices (5) each arranged within an inner cavity of the respective leg (3), within a portion of the leg spaced apart from the main axis (2A), with a winding axis (51A) located at a position spaced apart from the main axis (2A).

8. A flexible clamping belt for use on a vehicle bicycle-carrying device for clamping a frame tube (T) of a bicycle on the device, wherein the flexible clamping belt (4B) comprises an elongated flat body (401) having a face (410) with a number of projections (411) which are spaced apart from each other in a longitudinal direction of the belt body (401) and configured to act as spacers when the flexible clamping belt (4B) is clamped around a bicycle tube (T), so as to define gaps (412) between the belt body (401) and the surface of the tube (T), through which any bicycle wire (W) extending adjacent to, and along, the bicycle tube (T) can be arranged.

9. Flexible clamping belt according to claim 8, wherein the projections (411) are arranged in pairs which are longitudinally spaced from each other, the projections (411) of each pair being spaced from each other in a direction transverse to the longitudinal direction of the belt (4B), at the two sides of a belt longitudinal median axis (M).

10. Flexible clamping belt according to claim 8, wherein each of the longitudinally spaced projections (411) is elongated in a direction transverse to the longitudinal direction of the belt (4B) and occupies a major portion of the width of the belt (4B).

11. Flexible clamping belt according to claim 8, wherein the first face of the belt has a T-shaped projection (408) which is adapted to be received by a sliding movement within a cooperating seat (409) of one of the arms (4) for anchoring the clamping belt (4B) to the arm (4).

12. Flexible clamping belt according to claim 8, wherein
the elongated flat body (401) has a first face (402) on which a ratchet rack (403) is formed,
a buckle (406) is provided at one end of the elongated flat body (401),
a pawl (404) is pivoted to the buckle (406), the pawl having a tooth (404A) biased by a spring (407) into engagement with the ratchet rack (403) in a clamped condition of the flexible clamping belt (4B), and
the elongated flat body (401) has a second face (410) having the projections (411).

13. Method for loading a bicycle on a bicycle-carrying device mounted on a vehicle,
wherein the bicycle-carrying device comprises:
a support structure (2),
a plurality of arms (4) carried by the support structure (2), for supporting one or more bicycles,
a number of flexible clamping belts (4B) anchored to the arms (4) and defining cradle-like portions for receiving a frame tube (T) of a bicycle carried by the bicycle-carrying device,
wherein each of the flexible clamping belts (4B) comprises an elongated flat body (401) having a face (410) which is provided with a number of projections (411) which are spaced apart from each other in a longitudinal direction of the belt body (401) and configured to act as spacers when the flexible clamping belt (4B) is clamped around a bicycle tube (T), so as to define gaps (412) between the belt body (401) and the surface of the tube (T), through which any bicycle wire (W) extending adjacent to, and along, the bicycle tube (T) can be arranged, and
wherein when the bicycle tube (T) is received and clamped within a flexible clamping belt (4B), any bicycle metal wire (W) extending adjacent to, and along, the tube (T) is arranged through one of the gaps (412) defined between the projections (411) of the belt (4B) which is clamped around the tube (T).
